(19) United States
(12) Patent Application Publication
(10) Pub. No.: US 2016/0074267 A1
(43) Pub. Date: Mar. 17, 2016

(54) Transfer Bridge

(71) Applicant: Elizabeth Alex, Layton, UT (US)

(72) Inventor: Franklin Alex, Layton, UT (US)

(73) Assignee: MOBILITY ENHANCEMENT, L.C., Layton, UT (US)

(21) Appl. No.: 14/854,997

(22) Filed: Sep. 15, 2015

Related U.S. Application Data
(60) Provisional application No. 62/050,576, filed on Sep. 15, 2014.

(51) Int. Cl. A61G 7/10

(52) U.S. Cl. CPC A61G 7/103

(57) ABSTRACT

An apparatus, system, and method to transfer an individual between seating surfaces. The apparatus, in one embodiment, includes a substantially planar transfer surface, a seat-engaging surface, and at least one support member. The seat-engaging surface is disposed opposite the transfer surface. Each support member extends outward from the seat-engaging surface and each support member includes a contoured surface that extends between a first end and a second end of the support members. The contoured surfaces are configured to engage vertical surfaces of a corresponding first seating surface and a second seating surface. An individual slides along the transfer surface of the apparatus from the first seating surface to second seating surface to move between the seating surfaces.

### CROSS-REFERENCES TO RELATED APPLICATIONS

This application claims the benefit of U.S. Provisional Patent Application Number 62/050,576 entitled “TRANSFER BRIDGE” and filed on Sep. 15, 2014 for Franklin Alex, which is incorporated herein by reference.

### FIELD OF THE INVENTION

This invention relates to patient mobility and more particularly relates to transfer bridges for transferring patients between two seating surfaces.

### BACKGROUND

A transfer bridge is a rigid elongated member useful to help an individual move from one chair, bed, or other seat to another. Transfer bridges are often used by individuals that are mostly incapable of bearing their own weight for various reasons (e.g., injury, stroke, etc.). In use, the transfer bridge is positioned between, for example, a powered or manual wheelchair and another seating surface. Oftentimes transfers between seating surfaces occurs between surfaces with unequal heights, and transfer board shift (i.e., lateral movement of the transfer board) may be problematic. A transfer board having a relatively high coefficient of friction may alleviate transfer board shifts by gripping the opposing seating surfaces but are inefficient in sliding the user between the two seating surfaces.

### SUMMARY

From the foregoing discussion, it should be apparent that a need exists for an apparatus, system, and method to transfer an individual between seating surfaces that avoids problems associated with transfer board shifts. Beneficially, such an apparatus, system, and method would include a transfer board having a transfer surface with a relatively low coefficient of friction.

The present invention has been developed in response to the present state of the art, and in particular, in response to the problems and needs in the art that have not yet been fully solved by currently available transfer boards. Accordingly, the present invention has been developed to provide an apparatus, system, and method for transferring an individual between seating surfaces that overcome many or all of the above-discussed shortcomings in the art.

The transfer board, in one embodiment, includes a substantially planar transfer surface, a seat-engaging surface, and at least one support member. The seat-engaging surface is disposed opposite the transfer surface. Each support member extends outward from the seat-engaging surface and each support member includes a contoured surface that extends between a first end and a second end of the support members. The contoured surfaces are configured to engage vertical surfaces of a corresponding first seating surface and a second seating surface. An individual slides along the transfer surface of the transfer board from the first seating surface to second seating surface.

In certain embodiments, the transfer board includes at least one support mount that extends outwardly from the seat-engaging surface and extends longitudinally along the seat-engaging surface. In such an embodiment, the support members are coupleable to the support mount.

In one embodiment, the support mounts extend longitudinally along the seat-engaging surface for a distance in a range of between about four inches and about ten inches. In an exemplary embodiment, the support mounts extend longitudinally along the seat-engaging surface for a distance in a range of between about six inches and about eight inches.

The transfer board, in an exemplary embodiment, includes two support mounts. Each support mount is oriented in a substantially parallel configuration longitudinally along the seat-engaging surface of the transfer bridge. In such an embodiment, each support mount includes a tab that extends inwardly in a substantially perpendicular direction with reference to the support mounts. The support members are coupleable to the tabs of the support mounts.

The transfer surface of the transfer board, in one embodiment, has a first coefficient of friction and the seat-engaging surface has a second coefficient of friction. In such an embodiment, the first coefficient of friction is lower than the second coefficient of friction such that an individual can easily slide along the transfer surface while the seat-engaging surface remains positioned between two seating surfaces.

In another embodiment, the transfer surface includes a transfer surface coating having a first coefficient of friction and the seat-engaging surface includes a seat-engaging surface coating having a second coefficient of friction. In such an embodiment, the first coefficient of friction may be lower than the second coefficient of friction such that an individual can easily slide along the transfer surface while the seat-engaging surface remains positioned between two seating surfaces.

In an exemplary embodiment, at least the transfer surface of the transfer board is made of a conductive material configured to receive a coating having a lower coefficient of friction than a material comprising the seat-engaging surface. Of course, one of skill in the art will recognize that both the transfer surface and the seat-engaging surface of the transfer board may be made of a conductive material configured to receive coatings of various materials.

A method of the present invention is also presented for transferring an individual between seating surfaces. The method in the disclosed embodiments substantially includes the steps necessary to carry out the functions presented above with respect to the operation of the described transfer board. In one embodiment, the method includes positioning a first seating surface adjacent a second seating surface. In such an embodiment, the first seating surface and the second seating surface should include at least one vertical surface. The transfer bridge is positioned between the first seating surface and the second seating surface. The contoured surfaces of the support members are positioned to engage the vertical surfaces of the first seating surface and the second seating surface. With the transfer bridge thus positioned, the individual is transferred from the first seating surface to the second seating surface.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the subject matter will be readily understood, a description of the subject matter will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the accompanying drawings, in which:

FIG. 1 is a perspective view diagram illustrating one embodiment of transfer bridge in accordance with embodiments of the present disclosure;

FIG. 2 is an exploded view diagram illustrating one embodiment of the transfer bridge in accordance with embodiments of the disclosure;

FIG. 3 is a perspective view diagram illustrating one embodiment of a support member in accordance with embodiments of the disclosure;

FIG. 4 is a block diagram depicting an embodiment of a cross-section of the transfer bridge in accordance with embodiments of the disclosure;

FIG. 5 is a perspective view diagram illustrating one embodiment of an environment for using the transfer bridge in accordance with embodiments of the disclosure; and

FIG. 6 is a schematic flowchart diagram illustrating one embodiment of a method 600 for using the transfer bridge in accordance with embodiments of the disclosure.

### DETAILED DESCRIPTION

Embodiments of the present disclosure describe a transfer bridge or board. A transfer bridge is a rigid elongated member useful to help an individual move from one chair, bed, or other seat to another. Transfer bridges are often used by individuals that are mostly incapable of bearing their own weight for various reasons (e.g., injury, stroke, etc.). As will be described below, the transfer bridge may be positioned between, for example, a powered or manual wheelchair and another seating surface. Oftentimes transfers between seating surfaces occurs between surfaces with unequal heights, and transfer board shift may be problematic. Beneficially, the transfer bridge described below includes support surfaces that engage lateral (i.e., substantially vertical) surfaces of the seating surfaces and prevent any shifting of the transfer board. Further, a transfer surface (i.e., the sliding surface) may be coated with a coating selected to reduce a coefficient of friction of the sliding surface. These features and advantages are described herein below.

Reference throughout this specification to “one embodiment,” “an embodiment,” or similar language means that a particular feature, structure, or characteristic described in connection with the embodiment is included in at least one embodiment of the present subject matter. Thus, appearances of the phrases “in one embodiment,” “in an embodiment,” and similar language throughout this specification may, but do not necessarily, all refer to the same embodiment.

Furthermore, the described features, structures, or characteristics of the subject matter may be combined in any suitable manner in one or more embodiments. In the following description, numerous specific details are provided for a thorough understanding of embodiments of the subject matter. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the subject matter.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

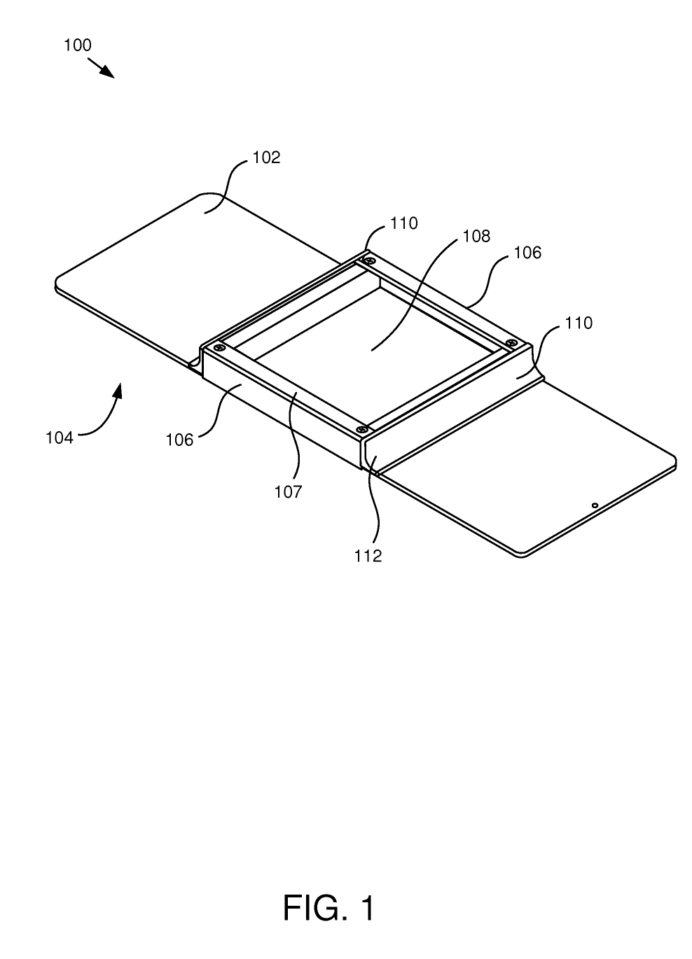

FIG. 1 is a perspective view diagram illustrating one embodiment of transfer bridge 100 in accordance with embodiments of the present disclosure. In the depicted embodiment, the transfer bridge 100 is an elongated and rigid member. The transfer bridge 100 may be formed of a substantially rigid material selected to support the weight of an individual. One example of a substantially rigid material capable of use with the embodiments of the disclosure is aluminum. In particular, aluminum alloys known for strength and rigidity may be used. Other metals and/or metal alloys may also be contemplated.

The transfer bridge 100, in one embodiment is formed of a conductive material to aide in the adherence of coatings. For example, the transfer bridge 100 may be formed of a metal so that a powder coating may be applied. Alternative coatings and finishes are also contemplated, including but not limited to, a PTFE coating, an anodized finish, etc. In another embodiment, and as will be described below, different coatings may be applied to different surfaces. For example, a wear resistant coating may be applied to a seat-engaging surface 102, and a low coefficient of friction coating may be applied to a transfer (i.e., individual-engaging) surface 104.

In one embodiment, the seat-engaging surface 102 and the transfer surface 104 are opposing surfaces of the transfer bridge 100. The transfer bridge 100 may be formed of a plate of the rigid material, and include support mounts 106 that extend outward from the seat-engaging surface 102 in a substantially perpendicular direction. The support mounts 106, in one embodiment, extend longitudinally along sides of the transfer bridge 100, for a distance in the range of between about 4 and 10 inches. In another embodiment, the distance or length of the support mounts 106 is in the range of between about 6 and 8 inches. As will be described below, this distance is representative of a gap between seating surface (e.g., bed, couch, chair, etc.) across which the individual will pass while transferring him or herself from one seating surface to another.

In one embodiment, the support mounts 106 extend outward from the seat-engaging surface 102 a distance in the range of between about 0.5 and 5 inches. In another embodiment, the support mounts 106 extend outward from the seat-engaging surface 102 a distance in the range of between about 1 and 3 inches. In the depicted embodiment, the support mounts 106 are oriented in a substantially parallel configuration along the opposing longitudinal edges of the transfer bridge 100. In another embodiment, the support mounts 106 may be positioned near a center 108 of the transfer bridge 100. In other words, the support mounts 106 need not be positioned along the edge of the transfer bridge 100. In yet another embodiment, the support mounts 106 include tabs 107 that extend towards each other. Stated differently, the tabs 107 extend inward in a substantially perpendicular direction with reference to the support mount. The tabs 107, together with their corresponding support mounts 106, form a rigid surface to which the support members 110 may be coupled.

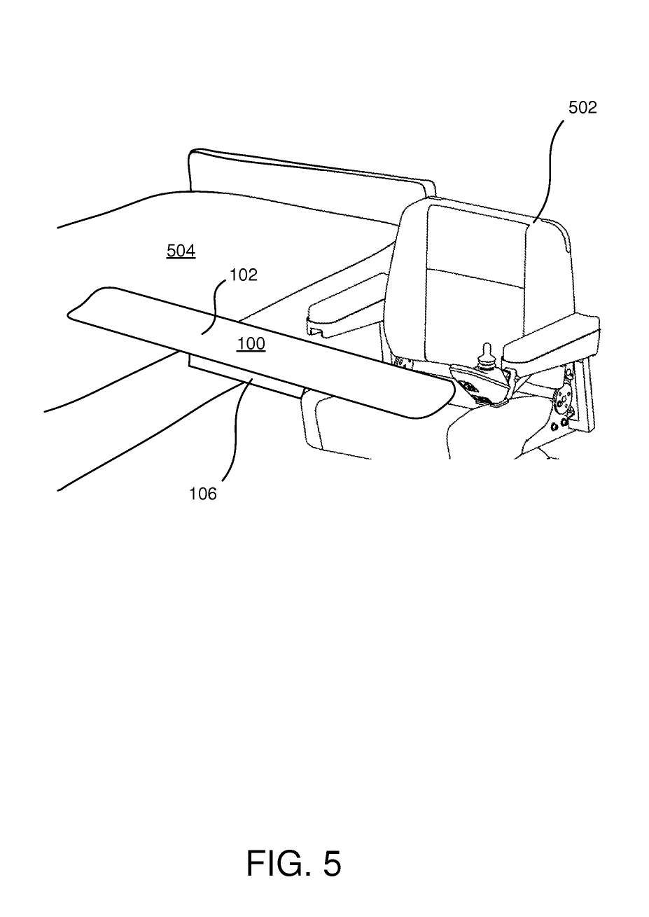

In one embodiment, each support member 110 is disposed between a corresponding support mount 106. The support members 110, as depicted, couple to the support mounts 106 and engage the seat-engaging surface 102. The support members 110 are configured with contoured surfaces 112 selected to engage a side of a seat. For example, the contoured surface 112 may have a shape selected to match a contour of a group 2 power chair (see FIG. 5). The contoured surfaces 112 function to prevent “slip” or lateral movement of the transfer bridge 100 when an individual is “scooting” across the transfer surface 104 by abutting vertical surfaces of the adjacent seats.

The support members 110, in one embodiment, may be formed of a substantially rigid material, examples of which include but are not limited to, polymer-based materials, metallic-based materials, and ceramic materials. In one embodiment, the support members 110 are formed by injection-molding of a polymer, such as polyethylene.

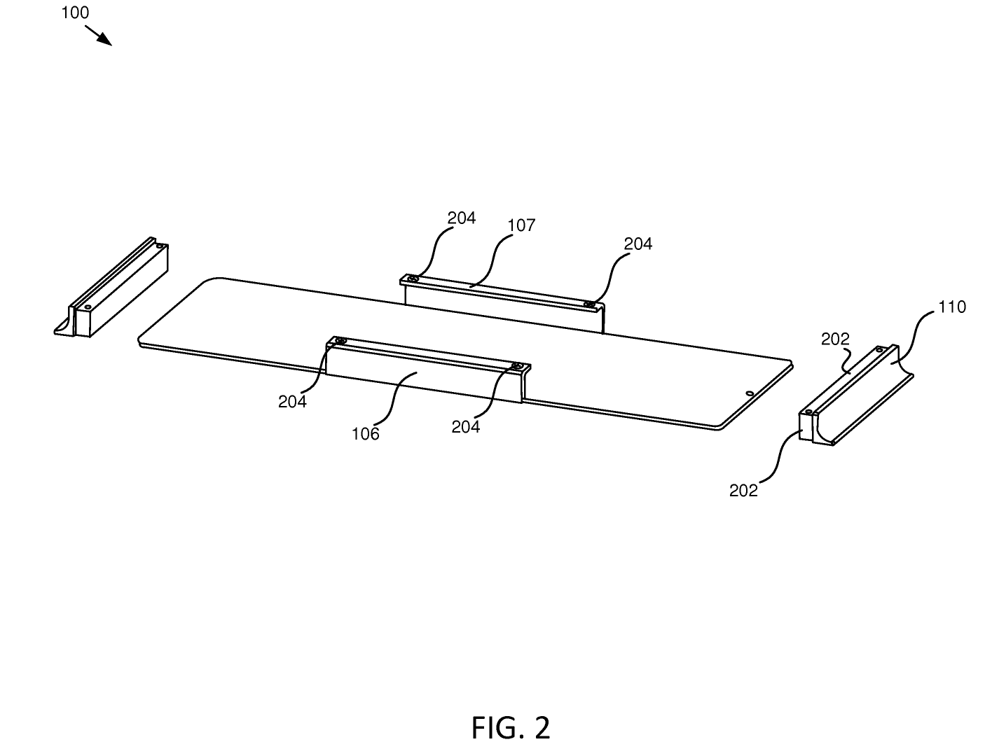

FIG. 2 is an exploded view diagram illustrating one embodiment of the transfer bridge 100 in accordance with embodiments of the disclosure. In the depicted embodiment, the support members 110 are formed with surfaces 202 for engaging the support mounts 106. The surfaces 202 have dimensions selected to insert into a “frame” formed by the support mounts 106. Fasteners (not shown) may pass through openings 204 in the tabs 107 to couple the support members 110 to the support mounts 106. In an alternative embodiment, the support members 110 are formed as part of the transfer bridge 100.

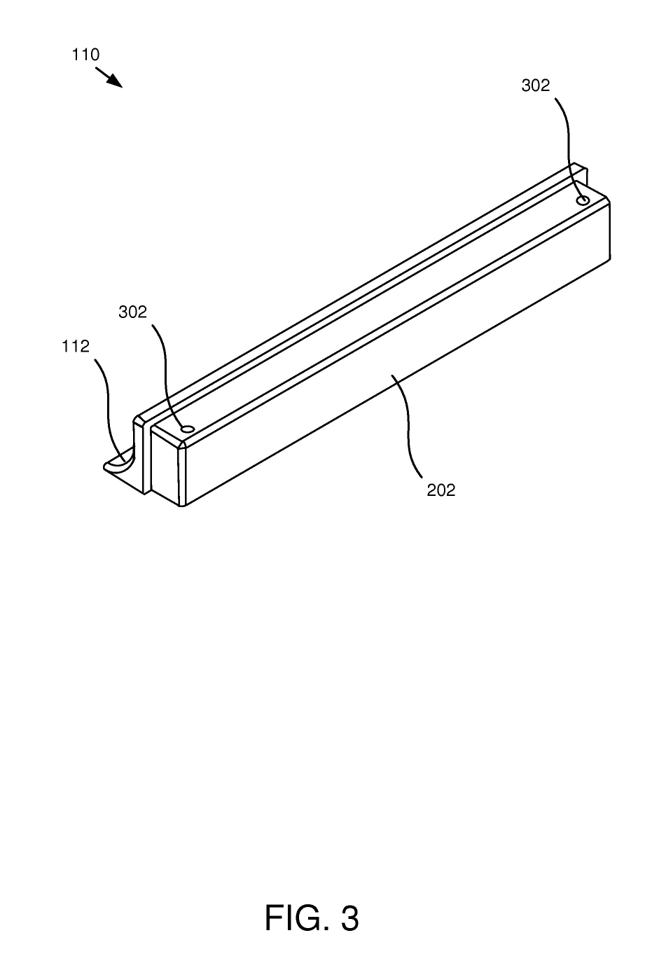

FIG. 3 is a perspective view diagram illustrating one embodiment of a support member in accordance with embodiments of the disclosure. The support member 110, as described above, may be formed of an injection-molded polymer. In alternative embodiments, the support member 110 may be formed of a machined or cast metal. The support member 110 is formed having a seat-engaging contoured surface 112 and a support-member-engaging surface 202.

In one embodiment, the support member 110 has a length in the range of between about 5 and 15 inches. In another embodiment, the support member 110 has a length in the range of between about 7 and 9 inches. The height of the surface 202 is selected to engage the opening formed by the support mounts 106 of FIG. 1. In one embodiment, this height is in the range of between about 0.5 and 3 inches. In another embodiment, this height is in the range of between about 0.75 and 1.25 inches.

Like the tabs 107, the support member 110 includes openings 302 for engaging a fastener. The openings 302 may be threaded for engaging a threaded fastener. Other types of fasteners are contemplated.

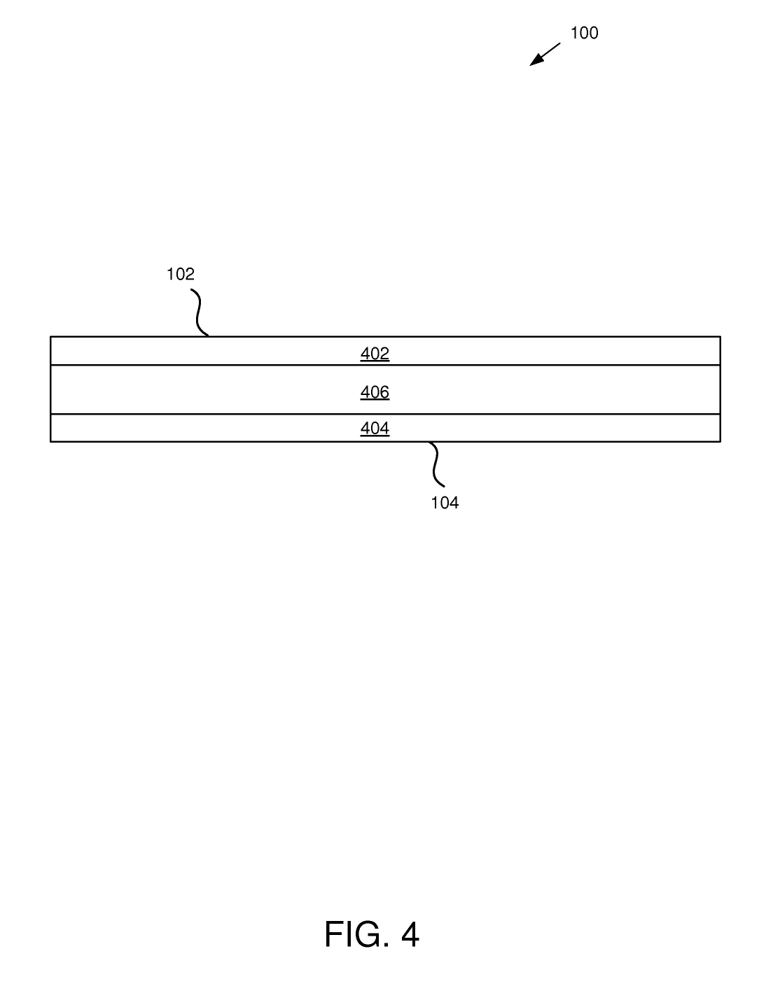

FIG. 4 is a block diagram depicting an embodiment of a cross-section of the transfer bridge 100 in accordance with embodiments of the disclosure. As described previously, the transfer bridge 100 may be formed having different coatings or finishes. In one embodiment, the transfer bridge 100 is formed with a transfer surface 102 coating 402 and a seat-engaging surface 104 coating 404.

In one example, the transfer bridge 100 is formed of a material 406 that is conductive so that a powder coating or a PTFE coating may be applied as the coating 402 and/or the coating 404. In some embodiments, the coating 402 is the same as the coating 404. In alternative embodiments, the coating 402 is selected to have a lower coefficient of friction than the coating 404. This allows the individual to slide across the transfer surface while the coating 404 helps to maintain the position of the transfer bridge 100 with reference to adjacent seating surfaces. In alternative embodiments, only the transfer surface 102 includes a coating 402 while the seat-engaging surface 104 remains substantially free of a coating 404. In such an embodiment, the coating 402 applied to the transfer surface 102 may be selected to have a lower coefficient of friction than the material comprising the seat-engaging surface 104.

FIG. 5 is a perspective view diagram illustrating one embodiment of an environment for using the transfer bridge 100 in accordance with embodiments of the disclosure. The transfer bridge 100 may be utilized to aid in the transfer of an individual from a powered wheelchair 502 (non-essential elements of which are omitted for clarity) to a bed 504. The transfer bridge 100 is positioned so that the support members 106 span a gap between the wheelchair 502 and the bed 504. It should be noted that the wheelchair 502 and the bed 504 are given by way of example only, and the transfer bridge 100 may be used to aid the transfer of an individual from any one seating surface to another seating surface.

Although not visible in this depiction, the contoured surfaces 112 of the support members 110 engage, respectively, the bed 504 and the wheelchair 502. As such, the transfer bridge 100 is prevented from slipping, or moving as the individual slides across the transfer surface 102 of the transfer bridge 100.

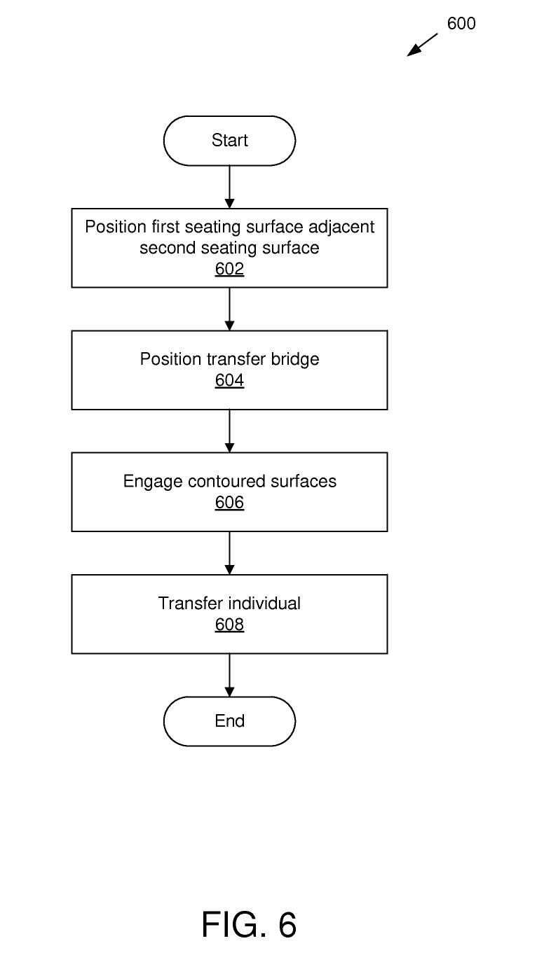

FIG. 6 is a schematic flowchart diagram illustrating one embodiment of a method 600 for using the transfer bridge 100 in accordance with embodiments of the disclosure. The method begins, and at block 602, the individual positions a first seating surface adjacent a second seating surface. Examples of seating surfaces include, but are not limited to, chairs, beds, couches, car seats, wheelchairs, etc.

At block 604, the transfer bridge 100 is positioned between the seating surfaces, such that the support members are disposed within a gap between the seating surfaces, and the ends of the transfer bridge 100 rest on top of the seating surfaces. At block 606, the contoured surfaces are positioned to engage vertical surfaces (e.g., the edge of a chair) of the seating surfaces. In this manner, the transfer board is prevented from slipping or moving with reference to the seating surfaces. At block 608, the individual is transferred from the first seating surface to the second seating surface by sliding across the transfer bridge 100.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An transfer board comprising:
a substantially planar transfer surface across which an individual may slide from a first seating surface to a second seating surface;
a seat-engaging surface opposite the transfer surface;
at least one support member extending outward from the seat-engaging surface having a first end and a second end; and
a contoured surface coupled to each of the first end and the second end, each contoured surface configured to engage a vertical surface of the corresponding first seating surface and the second seating surface.

2. The transfer board of claim 1, further comprising at least one support mount, wherein the at least one support mount extends outwardly from the seat-engaging surface and extends longitudinally along the seat-engaging surface.

3. The transfer board of claim 2, wherein the at least one support member is coupleable to the at least one support mount.

4. The transfer board of claim 2, wherein the at least one support mount extends longitudinally along the seat-engaging surface for a distance in a range of between about four inches and about ten inches.

5. The transfer board of claim 2, wherein the at least one support mount extends longitudinally along the seat-engaging surface for a distance in a range of between about six inches and about eight inches.

6. The transfer board of claim 2, wherein the at least one support mount comprises two support mounts, each support mount oriented in a substantially parallel configuration longitudinally along the seat-engaging surface of the transfer bridge.

7. The transfer board of claim 6, wherein each support mount further comprises a tab, each tab extending inwardly in a substantially perpendicular direction with reference to the support mounts.

8. The transfer board of claim 1, wherein the transfer surface has a first coefficient of friction and wherein the seat-engaging surface has a second coefficient of friction, wherein the first coefficient of friction is lower than the second coefficient of friction.

9. The transfer board of claim 1, wherein the transfer surface includes a transfer surface coating having a first coefficient of friction and wherein the seat-engaging surface includes a seat-engaging surface coating having a second coefficient of friction, wherein the first coefficient of friction is lower than the second coefficient of friction.

10. The transfer board of claim 1, wherein the transfer surface comprises a conductive material configured to receive a coating having a lower coefficient of friction than a material comprising the seat-engaging surface.

11. An apparatus to transfer an individual between seating surfaces, the apparatus comprising:
a substantially planar transfer surface across which an individual may slide from a first seating surface to a second seating surface;
a seat-engaging surface opposite the transfer surface;
at least one support mount extending outwardly from the seat-engaging surface and longitudinally along the seat-engaging surface;
at least one support member coupleable to the at least one support mount, the at least one support member having a first end and a second end; and
a contoured surface coupled to each of the first end and the second end, each contoured surface configured to engage a vertical surface of the corresponding first seating surface and the second seating surface.

12. The apparatus of claim 11, wherein the at least one support mount comprises two support mounts and wherein the at least one support member comprises two support members, each support mount oriented in a substantially parallel configuration longitudinally along the seat-engaging surface of the transfer bridge, each support member extending between, and coupleable to, opposing ends of the support mounts.

13. The apparatus of claim 12, wherein the two support mounts are positioned along opposing longitudinal edges of the seat-engaging surface.

14. The apparatus of claim 12, wherein the two support mounts are positioned adjacent a center of the seat-engaging surface.

15. The apparatus of claim 12, wherein each support mount further comprises a tab, each tab extending inwardly in a substantially perpendicular direction with reference to the support mounts to form a frame for coupling the support members to the support mounts.

16. The apparatus of claim 11, wherein the transfer surface has a first coefficient of friction and wherein the seat-engaging surface has a second coefficient of friction, wherein the first coefficient of friction is lower than the second coefficient of friction.

17. The apparatus of claim 11, wherein the transfer surface includes a transfer surface coating having a first coefficient of friction and wherein the seat-engaging surface includes a seat-engaging surface coating having a second coefficient of friction, wherein the first coefficient of friction is lower than the second coefficient of friction.

18. The apparatus of claim 11, wherein the transfer surface comprises a conductive material configured to receive a coating having a lower coefficient of friction than a material comprising the seat-engaging surface.

19. A method to transfer an individual between seating surfaces, the method comprising:
positioning a first seating surface adjacent a second seating surface, the first seating surface and the second seating surface having at least one vertical surface;
positioning a transfer bridge between the first seating surface and the second seating surface, the transfer bridge comprising:
a substantially planar transfer surface across which an individual may slide from a first seating surface to a second seating surface;
a seat-engaging surface opposite the transfer surface;
at least one support member extending outward from the seat-engaging surface having a first end and a second end; and
a contoured surface coupled to each of the first end and the second end, each contoured surface configured to engage a vertical surface of the corresponding first seating surface and the second seating surface;
positioning the contoured surfaces to engage the vertical surfaces of the first seating surface and the second seating surface; and
transferring the individual from the first seating surface to the second seating surface.
